(19) United States
(12) Patent Application Publication
(10) Pub. No.: US 2013/0078864 A1
(43) Pub. Date: Mar. 28, 2013

(54) Power Socket Connector And Conductive Terminal Thereof

(71) Applicants: Chia Yen Tsai, Dongguan City (CN); Guo Qi Kong, Dongguan City (CN)

(72) Inventors: Chia Yen Tsai, Dongguan City (CN); Guo Qi Kong, Dongguan City (CN)

(73) Assignee: SUYIN ELECTRONICS (DONGGUAN) CO., LTD., Dongguan City (CN)

(21) Appl. No.: 13/239,868

(22) Filed: Sep. 22, 2011

(51) Int. Cl. H01R 24/28

(52) U.S. Cl. 439/660

(57) ABSTRACT

The present invention discloses a power socket connector, including an insulating body, a shielding case body outwardly covering the insulating body, and a terminal set installed in the insulating body. The terminal set includes a central contact terminal and a conductive terminal disposed on two sides of the central contact terminal. The conductive terminal includes a vertical flexible contact portion and a horizontal flexible contact portion, and the vertical flexible contact portion and the horizontal flexible contact portion are connected to an L-shaped holding portion via a vertical connecting portion and a horizontal connecting portion, respectively. When a butt joint power plug is inserted into the power socket connector, the vertical/horizontal flexible contact portions of the conductive terminals are simultaneously abutted against the butt joint power plug to increase the high current crossing area, thereby increasing the current conductive stability and avoiding high temperature burnout of the connector.

### BACKGROUND OF THE INVENTION

1. Field of the Invention

The present invention relates to a technical field of a power socket connector, and in particular relates to a power socket connector providing multiple terminal contact points and a stable on-state current.

2. Description of the Related Art

Nowadays, notebook computers have been widely used and the given functions shall be proven by testing in a long-term operation. For that, the to-be-tested notebook computer shall be supplied with sufficient power from a power supply via a power socket connector disposed on one end thereof.

Referring to FIG. 1, the structure of a conventional power socket connector is illustrated. The conventional power socket connector includes an insulating body 10′, a terminal set 30′ installed in the insulating body 10′, and a shielding case body 20′ outwardly covering the insulating body 10′. Several plug-in slots are forwardly extended from a rear surface of the insulating body 10′ to respectively receive conductive terminals of the terminal set 30′. The terminal set 30′ of the conventional power socket connector includes a central contact terminal 31′, first conductive terminals 32′ disposed on two sides of the central contact terminal 31′, and a second conductive terminal 33′ disposed outside the first conductive terminal 32′. In FIG. 2, a schematic view of the structure of the first conductive terminal 32′ located at the site “A” in FIG. 1 is illustrated. The sheet-like first conductive terminal 32′ is formed with a vertical flexible contact portion 321′.

In the operation of the conventional power socket connector, the vertical flexible contact portion 321′ of the sheet-like first conductive terminal 32′ is utilized to contact a butt joint power plug (not shown in FIGs.). However, the conventional power socket connector has several difficulties needed to be solved as follows. First, because the vertical flexible contact portion 321′ of the sheet-like first conductive terminal 32′ only provides a single contact point, the current transport is unstable or even terminated if the single contact point of the vertical flexible contact portion 321′ is abnormal or failed, and the operation of the notebook computer may be stopped accordingly. Furthermore, if the contact point of the connector for current transport is insufficient, the connector is tended to be burned in a high-temperature condition, and hidden dangers such as unsafety may be occurred. The sheet-like first conductive terminal 32′ is tended to be permanently deformed after a long-term operation, so that the clamping force and contact effect of the sheet-like first conductive terminal 32′ are reduced.

### BRIEF SUMMARY OF THE INVENTION

In view of this, the main purpose of the present invention is to provide a power socket connector formed with vertical/horizontal flexible contact portions on the same terminal to contact the butt joint power plug, so that the amount of the contact points, the current crossing area and the stability of the current transport are increased, and the high-temperature condition caused by the insufficient contact point can be prevented.

To achieve the purposes above, the present invention is adopted with the technology projects as follows.

A power socket connector comprises an insulating body, a shielding case body outwardly covering the insulating body, and a terminal set installed in the insulating body. The terminal set includes a central contact terminal and a conductive terminal disposed on two sides of the central contact terminal. The conductive terminal includes a vertical flexible contact portion and a horizontal flexible contact portion, and the vertical flexible contact portion and the horizontal flexible contact portion are connected to an L-shaped holding portion via a vertical connecting portion and a horizontal connecting portion, respectively.

In a conductive terminal of a power socket connector of the present invention, the conductive terminal includes a vertical flexible contact portion and a horizontal flexible contact portion, and an L-shaped holding portion is connected to the vertical flexible contact portion and the horizontal flexible contact portion via a vertical connecting portion and a horizontal connecting portion, respectively.

Concretely speaking, it is understood that the present invention provides the following advantages and beneficial effects in accordance with the above-described technology projects, compared to the conventional skills The present invention mainly provides the conductive terminal with a combination structure of a vertical conductive terminal and a horizontal conductive terminal, so that the conductive terminal simultaneously includes a vertical flexible contact portion and a horizontal flexible contact portion. When the butt joint power plug is inserted into the power socket connector, the vertical flexible contact portions and the horizontal flexible contact portions of the conductive terminal are simultaneously abutted against the butt joint power plug to increase the high current crossing area, thereby increasing the current conductive stability, avoiding high temperature burnout of the connector due to insufficient contact points for on-state current, ensuring product safety when heavy current is applied, removing the hidden dangers, and extending the life span of the connector. Meanwhile, the insertion and extraction force of between the power socket connector and the butt joint power plug, the reliability of the plugged connector, and the stability of the signal communication can be increased.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of an assembling structure of a conventional art;

FIG. 2 is an enlarged view of a terminal located at the site “A” in FIG. 1;

FIG. 3 is a schematic view of an exploded structure of an embodiment of the present invention;

FIG. 4 is a schematic view of an assembling structure of an embodiment of the present invention;

FIG. 5 is a rear view of the assembling structure in FIG. 4;

FIG. 6 is an enlarged view of a terminal located at the site “B” in FIG. 4;

FIG. 7 is a sectional view showing an embodiment of the present invention without installation of a terminal set;

FIG. 8 is a sectional view showing the embodiment in FIG. 7 to be installed with a terminal set; and

FIG. 9 is another sectional view showing the embodiment installed with the terminal set.

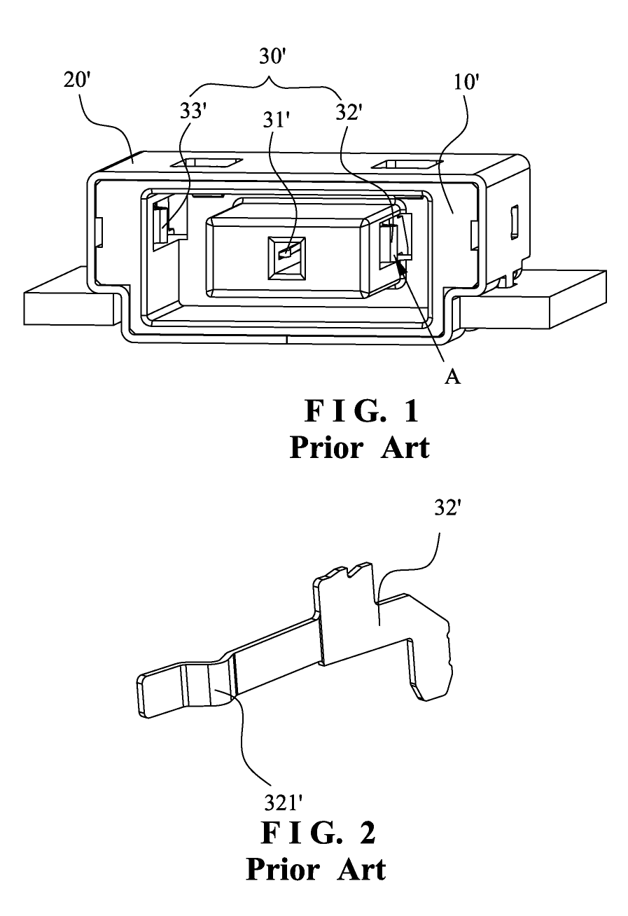

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

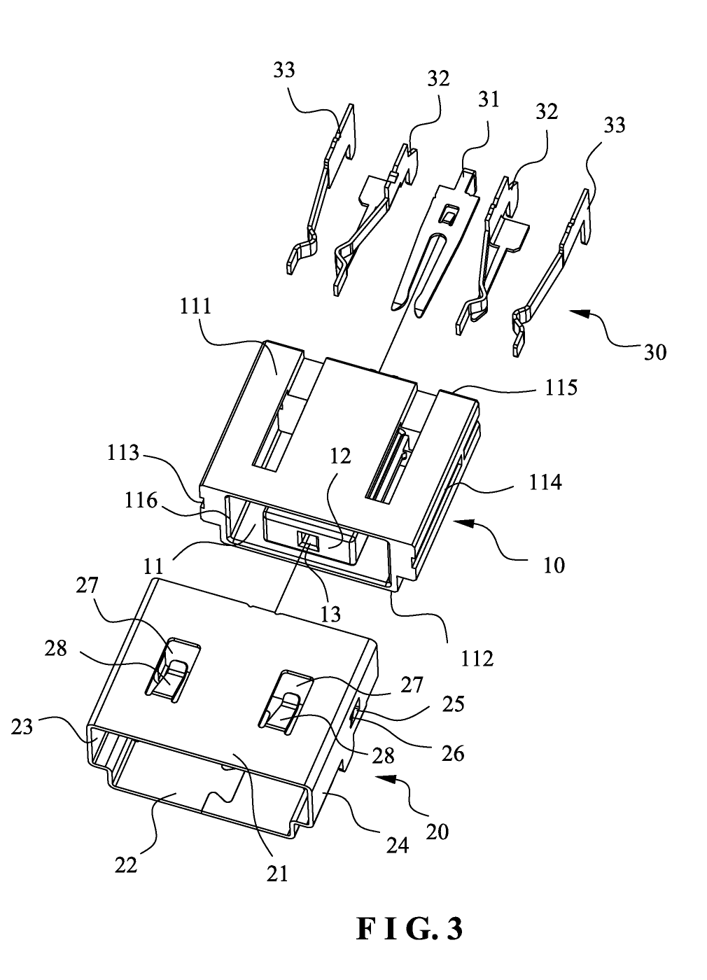

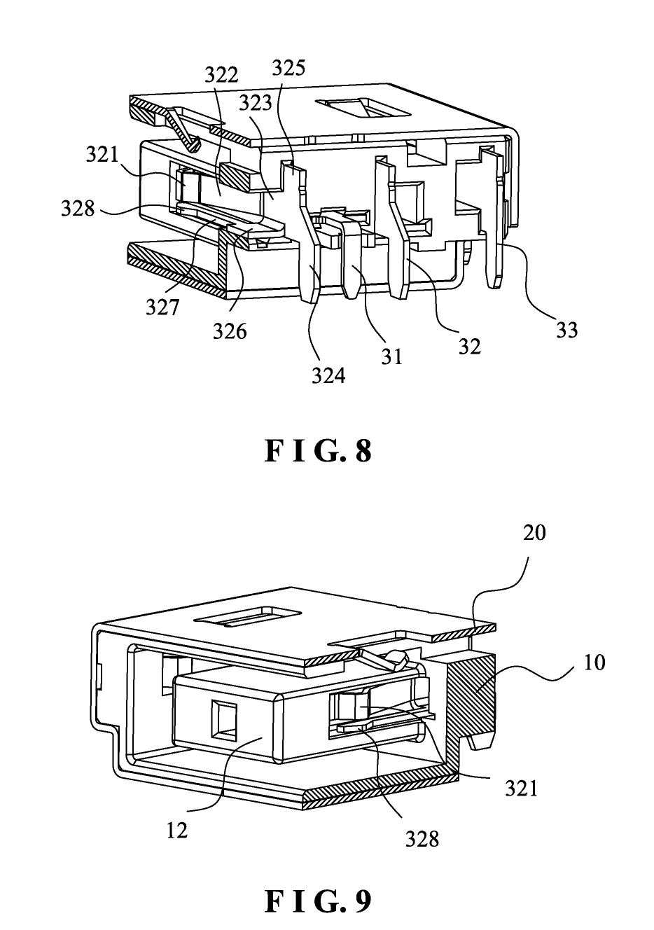

Referring to FIGS. 3 to 9, a physical structure of a power socket connector of an embodiment of the invention is illustrated. The power socket connector comprises an insulating body 10, a shielding case body 20 outwardly covering the insulating body 10, and a terminal set 30 installed in the insulating body 10.

The insulating body 10 made of plastic material has an accommodation room 11 matchly inserted by a power plug (not shown in FIGs.). The accommodation room 11 of the insulating body 10 is surroundingly formed by top wall 111, a bottom wall 112, a left side wall 113, a right side wall 114 and a rear end surface 115, providing an opening 116 at a front end thereof. In addition, a tongue plate 12 disposed in the insulating body 10 is extended from the rear end surface 115 of the insulating body 10. The tongue plate 12 includes a top end formed with a central plug-in slot 13 penetrated through to the rear end surface 115 of the insulating body 10. Two sides of the tongue plate 12 include middles formed with two first plug-in slots 14 penetrated through to the rear end surface 115 of the insulating body 10, the front end surface of the first plug-in slot 14 of the tongue plate 12 has an inner side forwardly recessed with a first positioning slot 141, and the top surface of the first plug-in slot 14 of the tongue plate 12 has in inner side upwardly recessed with a second positioning slot 142. A second plug-in slot 15 is formed at the outside of the two the first plug-in slots 14 of the tongue plate 12, wherein the two corresponded inner walls at two sides 113 and 114 of the insulating body 10 includes a middle formed with the second plug-in slot 15 penetrated through to the rear end surface 115 of the insulating body 10.

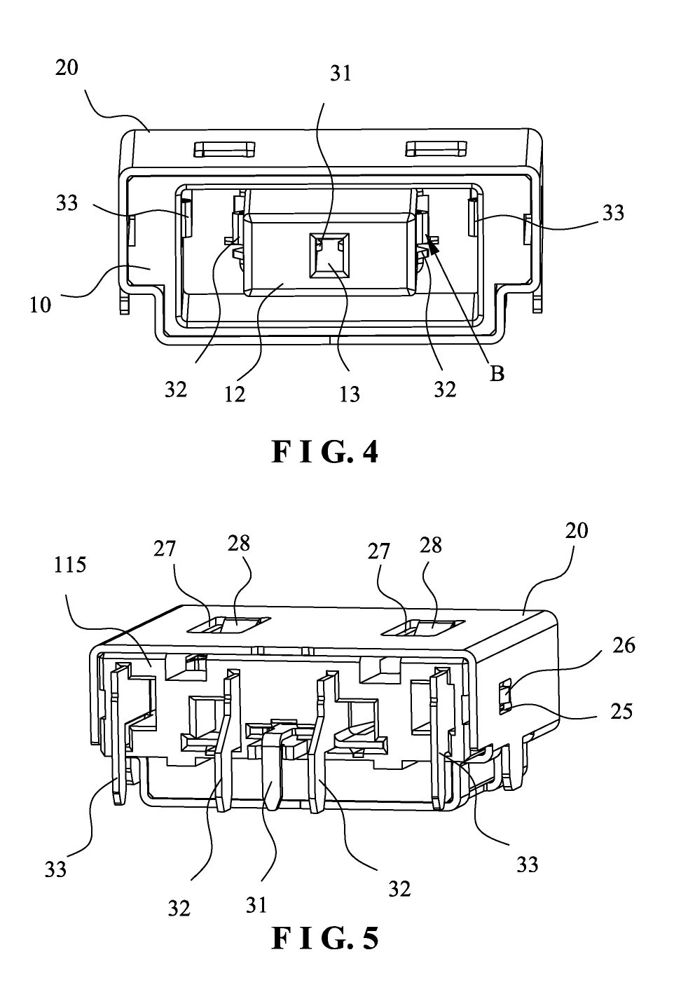

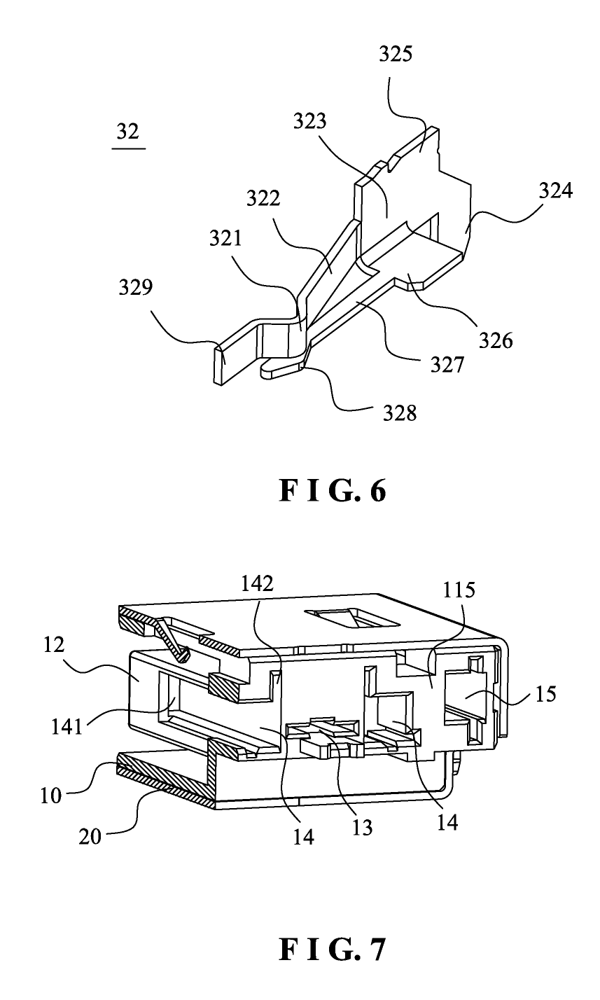

The terminal set 30 includes a central contact terminal 31, a conductive terminal 32 disposed on two sides of the central contact terminal 31, and two second conductive terminals 33, wherein the central contact terminal 31 is formed as a clamp opening structure to insert into the central plug-in slot 13 of the tongue plate 12, and the two the second conductive terminals 33 are formed as single-piece structures respectively inserted into the respective second plug-in slot 15 of the insulating body 10. The structures of the central contact terminal 31 and the second conductive terminal 33 are general components, and thus the detail descriptions thereof are omitted. In FIG. 6, an enlarged view of conductive terminal 32 located at the site “B” in FIG. 4 is illustrated. The conductive terminal 32 comprises a lateral and front-end vertical flexible contact portion 321, a vertical connecting portion 322, a vertical holding portion 323 and a vertical welded portion 324 to sequentially connect plate surfaces thereof. In the conductive terminal 32, the vertical flexible contact portion 321 is warpingly formed on the free tail end of the vertical connecting portion 322, an extension portion 329 is formed on a head end of the vertical flexible contact portion 321 to be embedded in the first positioning slot 141 of the first plug-in slot 14 of the tongue plate 12, and the vertical welded portion 324 is downwardly formed from the distal end of the vertical holding portion 323 for being welded to a circuit board. An interference portion 325 protrudedly formed on a top end of the vertical holding portion 323 to enhance stability is embedded in the second positioning slot 142 of the tongue plate 12. A horizontal holding portion 326 with a horizontal plate surface is vertically extended from the bottom end of the vertical holding portion 323, and the vertical holding portion 323 and the horizontal holding portion 326 are integrally connected to form a L-shaped holding portion. A horizontal connecting portion 327 and a horizontal flexible contact portion 328 are sequentially extended from the front end of the horizontal holding portion 326. The horizontal flexible contact portion 328 is a contact point protruded on the free tail end of the horizontal connecting portion 327, and the vertical flexible contact portion 321 and the horizontal flexible contact portion 328 are located at same side of the L-shaped holding portion and the contact points thereof are vertically corresponded to each other.

Referring to FIG. 3, the shielding case body 20, a frame border bent from a good conductive metal sheet, is divided into a top wall 21, a bottom wall 22, a left sidewall 23 and a right sidewall 24, wherein the left and right sidewalls 23 and 24 are formed with a first opening 25, a first elastic piece 26 inwardly-inclined and bent from one side of the first opening 25, the left and right sides of the top wall 21 are respectively formed with a second opening 27, and a second elastic piece 28 is extended from one side of the second opening 27.

In the assembling process, the terminals of the terminal set 30 are respectively inserted into the corresponding terminal plug-in slots. That is, the central contact terminal 31 is inserted into the central plug-in slot 13, the two conductive terminals 32 are respectively inserted into the corresponded first plug-in slots 14, and the two second conductive terminals 33 are respectively inserted into the corresponded second plug-in slots 15. In the assembling process of the two conductive terminals 32, it is noted that the extension portion 329 located on the front end of the vertical flexible contact portion 321 shall be embedded in the first positioning slot 141 of the first plug-in slot 14 of the tongue plate 12, and the interference portion 325 located on the top end of the vertical holding portion 323 shall be embedded in the second positioning slot 142 of the tongue plate 12, so that the first conductive terminal 32 can be securely engaged and fastened to the tongue plate 12 of the insulating body 10. Then, the shielding case body 20 is outwardly covered on the outer surface of the insulating body 10 to abut the two first elastic pieces 26 thereof against the two outer sidewalls of the insulating body 10, so that the assembling process of the power socket connector is completed.

In the operating process, when a butt joint power plug (not shown in FIGs.) is inserted into the power socket connector, the central contact terminal 31 and the vertical flexible contact portions 321/the horizontal flexible contact portions 328 of the two conductive terminals 32 are simultaneously abutted against the butt joint power plug, the contact portions of the two second conductive terminals 33 are respectively abutted against the different portions of the butt joint power plug, and the two second elastic pieces 28 of the shielding case body 20 are abutted against the butt joint power plug, thereby achieving the current transport.

What is claimed is:

1. A power socket connector, comprising an insulating body, a shielding case body outwardly covering the insulating body, and a terminal set installed in the insulating body, the terminal set including a central contact terminal and a conductive terminal disposed on two sides of the central contact terminal, characterized in that the conductive terminal includes a vertical flexible contact portion and a horizontal flexible contact portion, and the vertical flexible contact portion and the horizontal flexible contact portion are connected to an L-shaped holding portion via a vertical connecting portion and a horizontal connecting portion, respectively.

2. The power socket connector as claimed in claim 1, characterized in that the vertical flexible contact portion, the vertical connecting portion, the horizontal flexible contact portion, the horizontal connecting portion and the L-shaped holding portion are integrally formed.

3. The power socket connector as claimed in claim 1, characterized in that the vertical flexible contact portion and the horizontal flexible contact portion are located at same side of the L-shaped holding portion, and the contact points thereof are vertically corresponded to each other.

4. The power socket connector as claimed in claim 1, characterized in that a tongue plate is disposed in the insulating body, the tongue plate includes a top end formed with a central plug-in slot penetrated through to a rear end surface of the insulating body, and the central contact terminal of the terminal set is inserted into the central plug-in slot of the tongue plate.

5. The power socket connector as claimed in claim 4, characterized in that two sides of the tongue plate includes middles formed with first plug-in slots penetrated through to a rear end surface of the insulating body, and the conductive terminal of the terminal set is inserted into the first plug-in slot of the tongue plate.

6. The power socket connector as claimed in claim 5, characterized in that the vertical flexible contact portion of the conductive terminal includes a head end formed with an extension portion, the first plug-in slot of the tongue plate is recessed with a first positioning slot facing the extension portion of the vertical flexible contact portion, and the extension portion of the vertical flexible contact portion of the conductive terminal is embedded in the first positioning slot of the first plug-in slot of the tongue plate.

7. The power socket connector as claimed in claim 5, characterized in that the L-shaped holding portion comprises a vertical holding portion and a horizontal holding portion integrally connected to the vertical holding portion, a top end of the vertical holding portion is formed with an interference portion, the first plug-in slot of the tongue plate is upwardly recessed with a second positioning slot facing the interference portion of the conductive terminal, and the interference portion of the conductive terminal is embedded in the second positioning slot of the tongue plate.

8. The power socket connector as claimed in claim 1, characterized in that the conductive terminal is a first conductive terminal, the power socket connector further comprises a second conductive terminal formed as a single-piece structure, two corresponded inner walls at two sides of the insulating body includes a middle formed with a second plug-in slot penetrated through to the rear end surface of the insulating body, and the second conductive terminal is correspondingly inserted into the respective second plug-in slot of the insulating body.

9. A conductive terminal of a power socket connector, characterized in that the conductive terminal simultaneously includes a vertical flexible contact portion and a horizontal flexible contact portion, and an L-shaped holding portion is connected to the vertical flexible contact portion and the horizontal flexible contact portion via a vertical connecting portion and a horizontal connecting portion, respectively.

10. The conductive terminal of the power socket connector as claimed in claim 9, characterized in that the L-shaped holding portion comprises a vertical holding portion and a horizontal holding portion integrally connected to the vertical holding portion, and a tail portion of the vertical holding portion is integrally extended with a vertical welded portion.
